(19) United States
(12) Patent Application Publication
(10) Pub. No.: US 2013/0050285 A1
(43) Pub. Date: Feb. 28, 2013

(54) ILLUMINATION DEVICE AND DISPLAY DEVICE

(71) Applicants: Kazuyuki Takahashi, Kanagawa (JP); Masahiro Saito, Kanagawa (JP); Toshifumi Yasui, Kanagawa (JP)

(72) Inventors: Kazuyuki Takahashi, Kanagawa (JP); Masahiro Saito, Kanagawa (JP); Toshifumi Yasui, Kanagawa (JP)

(73) Assignee: SONY CORPORATION, Tokyo (JP)

(21) Appl. No.: 13/564,096

(22) Filed: Aug. 1, 2012

(30) Foreign Application Priority Data
Aug. 22, 2011 (JP) 2011-180779

(51) Int. Cl. F21V 9/00; G09G 5/10; G09G 3/36; G02F 1/13357

(52) U.S. Cl. 345/690; 362/231; 349/62; 345/87

(57) ABSTRACT

An illumination device includes: a light source section including a laser light source; an optical element disposed on an optical path of a laser light beam emitted from the laser light source, branching an optical path of an incident light beam incident thereon into a plurality of optical paths, and allowing branched light beams to be output therefrom; an optical member receiving the branched light beams that travel along the plurality of optical paths, and allowing illumination light to be output therefrom based on the branched light beams; and a driver section driving the optical element to allow phases of the branched light beams to be changed independently of one another.

### BACKGROUND

The present disclosure relates to an illumination device that emits light including laser light, and a display device that displays an image by using such an illumination device.

Typically, a projector (or a projection display device) includes an optical module as a main component, and this optical module is constituted by an illumination optical system (or an illumination device) including a light source, and a projection optical system (or a profile optical system) including light modulation elements. In the field of such projectors, recently, compact (or palm sized), lightweight portable projectors called “micro projectors” have been increasingly dispersed. Typically, such a micro projector mainly includes a light emitting diode (LED), as a light source, in an illumination device.

On the other hand, lately, there is a growing interest in lasers used for new light sources in illumination devices. For instance, projectors equipped with a gas laser have been known, as projectors using laser lights of three primary colors, such as red (R), green (G), and blue (B). Examples of a projector using a laser as a light source, as described above, are proposed by Japanese Unexamined Patent Application Publications Nos. S55-65940 and H06-208089. By using a laser as a light source, projectors achieve a wide range of color reproduction and low power consumption.

### SUMMARY

Generally, when coherent light, such as laser light, is irradiated on a diffusing surface, spotty patterns may be observed thereon, as opposed to using other types of light. These patterns are called “speckle patterns”. When the light is irradiated on the diffusing surface, it is scattered randomly at various locations thereof, and the scattered lights of random phases, which are in accordance with the slightly uneven surface, interfere with one another. As a result, the speckle patterns are generated.

If a projector having a laser in a light source is used, the above speckle patterns (or interference patterns) are overlaid over an image displayed on a screen. These patterns may be recognized by human eyes as intense random noises, thus leading to the lowering of the displayed image quality. Speckle patterns generated in this manner may become a common disadvantage in using coherent laser light for light sources. Therefore, various attempts to reduce the generation of such speckle patterns (speckle noise) have been made so far.

For example, the above-mentioned document S55-65940 discloses a projector having a laser in the light source in which the piezoelectric element slightly vibrates the screen, in order to reduce the generation of such speckle patterns. Generally, it is difficult for human eyes and brains to recognize flickers on an image in a period of approximately 20 ms to 50 ms. Thus, human eyes integrate the variation in an image during such a short period, and recognize this average as the image. Therefore, this projector aims to average the speckle noises to the extent that the speckle noises are hardly recognized by human eyes, by overlaying a lot of independent speckle patterns on the screen during the short period. However, because it is necessary to slightly vibrate the large screen itself, this technique may involve the enlargement of the configuration in the projector.

Meanwhile, the above-mentioned document H06-208089 discloses a projector in which the diffuser element is mechanically rotated, thereby displacing speckle patterns on the screen at a high speed, so that the speckle noise is not sensed by human eyes. However, because the diffuser element is used to diffuse light, this technique may impair the utilization efficiency of light.

There is a need for an illumination device and a display device which achieve the compactness as well as improve the utilization efficiency of light while reducing the generation of interference patterns.

An illumination device according to an embodiment of the present disclosure includes: a light source section including a laser light source; an optical element disposed on an optical path of a laser light beam emitted from the laser light source, the optical element branching an optical path of an incident light beam incident thereon into a plurality of optical paths, and allowing branched light beams to be output therefrom; an optical member receiving the branched light beams that travel along the plurality of optical paths, and allowing illumination light to be output therefrom based on the branched light beams; and a driver section driving the optical element to allow phases of the branched light beams to be changed independently of one another.

A display device according to an embodiment of the present disclosure is provided with an illumination device and a light modulation element. The light modulation element modulates illumination light derived from the illumination device based on an image signal. The illumination device includes: a light source section including a laser light source; an optical element disposed on an optical path of a laser light beam emitted from the laser light source, the optical element branching an optical path of an incident light beam incident thereon into a plurality of optical paths, and allowing branched light beams to be output therefrom; an optical member receiving the branched light beams that travel along the plurality of optical paths, and allowing the illumination light to be output therefrom based on the branched light beams; and a driver section driving the optical element to allow phases of the branched light beams to be changed independently of one another.

In the illumination device and the display device according to the above-described respective embodiments of the present disclosure, the optical element disposed on the optical path of the laser light beam allows the branched light beams to be output therefrom by branching the optical path of the incident light beam into the plurality of optical paths. Also, the driver section drives the optical element so as to change the phases of the branched light beams traveling along the plurality of optical paths, independently of one another. This reduces the generation of interference patterns due to laser light. Furthermore, the optical member receives the branched light beams, and allows the illumination light to be output therefrom, on the basis of these branched light beams. This decreases or prevents an optical loss produced when the light beams enter the optical member from the optical element (or decreases or prevents the coupling loss of each branched light beam), even when the above optical element is driven.

According to the illumination device and the display device of the above-described respective embodiments of the present disclosure, there is provided: the optical element that branches the optical path of the incident light beam including the laser light beam into the plurality of optical paths and allows the branched light beams to be output therefrom; and the optical member that receives the branched light beams and allows the illumination light to be output therefrom. Also, the optical element is driven to allow the phases of the branched light beams to be changed independently of one another. This decreases or prevents the optical loss produced when the light beam enters the optical member from the optical element, while reducing the generation of interference patterns due to laser light. Consequently, it is possible to achieve the compactness as well as improve the utilization efficiency of light while reducing the generation of interference patterns (or improve the displayed image quality).

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to describe the principles of the technology.

FIG. 1 is a view illustrating an overall configuration of a display device according to an embodiment of the present disclosure.

FIG. 2 is a schematic view for explaining a far field pattern of a laser light beam emitted from a laser light source.

Parts (A) and (B) of FIG. 3 are schematic views for explaining an intensity distribution of a laser light beam emitted from the laser light source.

FIG. 4 is a schematic view for explaining a basic function of an optical element illustrated in FIG. 1.

FIGS. 5A and 5B are schematic views illustrating an exemplified, detailed configuration of the optical element illustrated in FIG. 4.

Parts (A) and (B) of FIG. 6 are schematic views for explaining a diffraction function which the optical element illustrated in FIG. 4 performs.

Parts (A) and (B) of FIG. 7 are schematic views for explaining an overlaying function of diffracted lights.

FIG. 8 is a schematic view illustrating an exemplified, detailed configuration of a fly eye lens illustrated in FIG. 1.

FIG. 9 is a view illustrating an overall configuration of a display device according to a comparative example 1.

FIG. 10 is a schematic view illustrating an exemplified vibration operation of the optical element.

Parts (A) to (C) of FIG. 11 are schematic views for explaining the change in the phase of light (diffracted light) emitted from the optical element illustrated in FIG. 10, during the vibration operation of the optical element.

FIGS. 12A and 12B are views depicting a configuration of an optical element according to Example 1.

FIGS. 13A to 13C are views depicting the diffraction characteristics of the optical element according to Example 1.

FIG. 14 is a schematic view illustrating a configuration of a measurement system for interference patterns according to Example 2.

FIG. 15 is a schematic view depicting a relationship between a projected region and a measurement region according to Example 2.

Parts (A) to (D) of FIG. 16 are characteristic diagrams depicting measurement results of interference patterns according to a comparative example 2 and Example 2.

FIGS. 17A to 17C are schematic views illustrating an exemplified vibration operation of an optical element according to a modification example 1.

FIG. 18 is a schematic view illustrating a configuration and a function of an optical element according to a modification example 2.

Parts (A) and (B) of FIG. 19 are schematic views illustrating a detailed configuration of a phase change element illustrated in FIG. 18.

Parts (A) and (B) of FIG. 20 are schematic views illustrating a detailed configuration of a prism array illustrated in FIG. 18.

FIGS. 21A and 21B are schematic views for explaining a basic function of the phase change element and the prism array illustrated in FIGS. 19 and 20, respectively.

FIG. 22 is a schematic view illustrating a configuration and a function of an optical element according to a modification example 3.

### DETAILED DESCRIPTION

Thereinafter, an embodiment of the present disclosure will be described in detail with reference to the accompanying drawings. Note that a description will be given in the following orders.

1. Embodiment (an example in which a diffraction element is used as an optical element)
2. Examples (Examples 1 and 2 according to the embodiment)
3. Modification examples

Modification example 1 (another example in which an optical element vibrates in an in-plane direction orthogonal to an optical axis thereof)

Modification example 2 (an example in which both a phase change element and a prism array are used as an optical element)

Modification example 3 (an example in which both a liquid crystal element and a prism array are used as an optical element)

### Other Modification Examples

### Embodiment

### Overall Configuration of Display Device 3

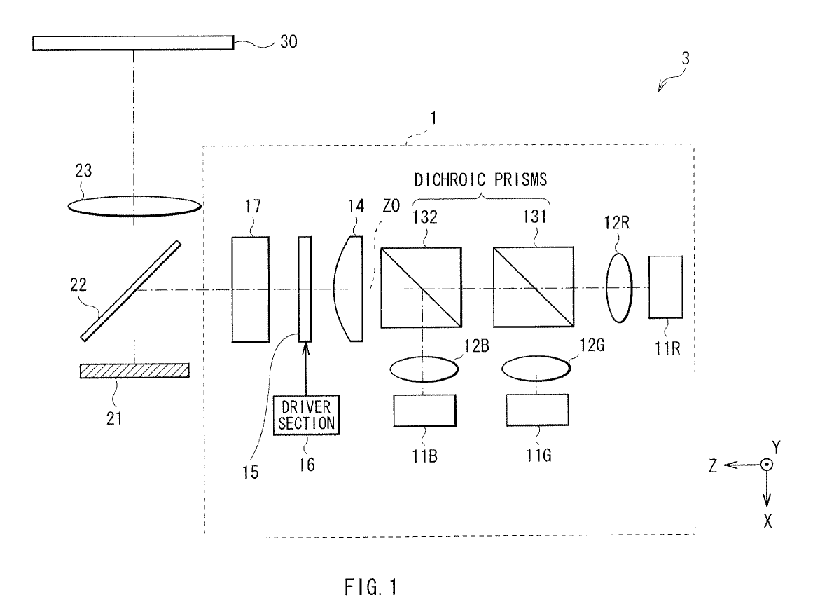

FIG. 1 illustrates an overall configuration of a display device (display device 3) according to an embodiment of the present disclosure. This display device 3 is a projection display device that projects an image (or an optical image) onto a screen 30 (or a projection surface). Specifically, the display device 3 includes an illumination device 1, and an optical system (or a display optical system) that displays an image by using illumination light from the illumination device 1.

### (Illumination Device 1)

The illumination device 1 includes a red laser 11R, a green laser 11G, a blue laser 11B, lenses 12R, 12G, and 12B, dichroic prisms 131 and 132, a condenser lens 14, an optical element (diffraction element) 15, a driver section 16, and a fly eye lens 17. Note that a reference mark “Z0” in this figure represents the optical axis.

The red laser 11R, the green laser 11G, and the blue laser 11B correspond to three types of light sources, and emit a red laser light beam, a green laser light beam, and a blue laser light beam, respectively. These laser light sources constitute a light source section, and each of the three types of light sources is a laser light source in this embodiment. Each of the red laser 11R, the green laser 11G, and the blue laser 11B may be, for example, a semiconductor laser, a solid-state laser, or the like. If each laser light source is a semiconductor laser, as one example, the wavelengths λr, λg, and λb of the red, green, and blue laser light beams are approximately 600 nm to 700 nm, 500 nm to 600 nm, and 400 nm to 500 nm, respectively.

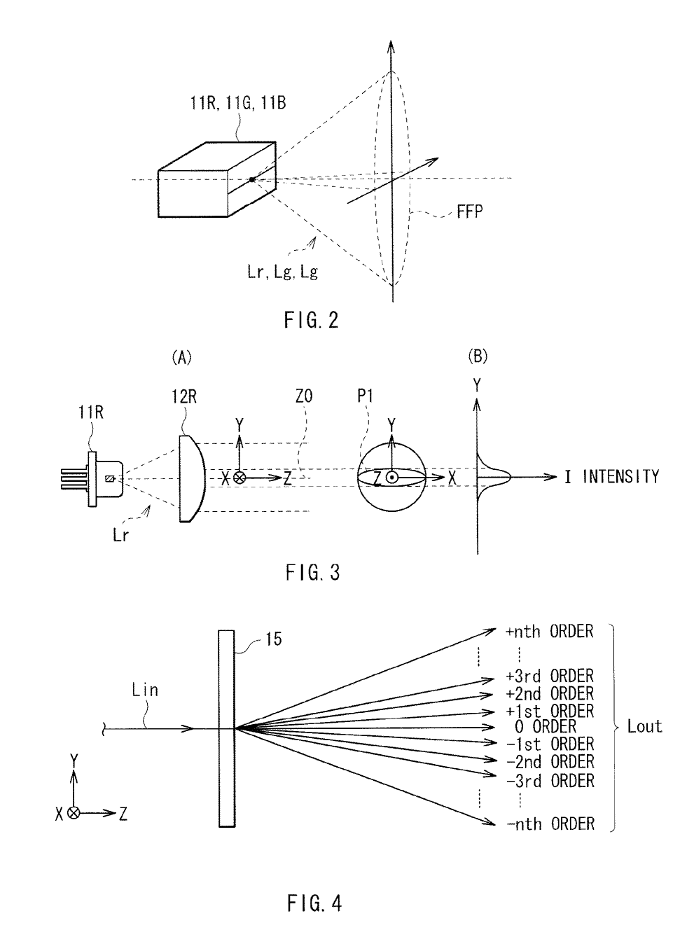

In the above configuration, for example, when each of the red laser 11R, the green laser 11G, and the blue laser 11B is composed of a semiconductor laser, the far field pattern (FFP) of a laser light beam emitted therefrom is, for example, as illustrated in FIG. 2. In more detail, the FFP of a laser light beam (red laser light beam Lr, the green laser light beam Lg, or the blue laser light beam Lb) emitted from a semiconductor laser has an elliptical shape or the like, not a circular (isotopic) shape.

The lenses 12R and 12G are lenses (or coupling lenses) that collimate the red laser light beam and the green laser light beam emitted from the red laser 11R and the green laser 11G, respectively (or convert the red and green laser light beams into parallel beams), then coupling the collimated light beams to the dichroic prism 131. Likewise, the lens 12B is a lens (or coupling lens) that collimates the blue laser light beam emitted from the blue laser 11B (or converts the blue laser light beam into a parallel beam), then coupling the collimated light beam to the dichroic prism 132. Note that in this embodiment, the lenses 12R, 12G, and 12B collimate the individual incident light beams (or generate the individual collimated light beams), however an embodiment of the present disclosure is not limited thereto. Alternatively, by omitting the lenses 12R, 12G, and 12B, the incident light beams may not be collimated (or may not be converted into parallel light beams). However, it is considered that collimating the light beams in the above manner is more preferable, in terms of the compactness of the configuration in the device.

As described above, for example, when each of the red laser 11R, the green laser 11G, and the blue laser 11B is composed of a semiconductor laser, the spatial luminance distribution (intensity distribution) of a laser light beam emitted therefrom is as follows. Specifically, because the FFP of the laser light (a red laser light Lr as an example in this case) emitted from the semiconductor laser has an elliptical shape, the intensity distribution of a laser light beam emitted from the collimator lens 12R or the like also has spatial inhomogeneity, for example, as illustrated in Parts (A) and (B) of FIG. 3. In more detail, referring to a region indicated by a reference mark P1 in Part (B) of FIG. 3 (which has an intensity of equal to or more than one-half the maximum intensity), the intensity distribution has the elliptical shape whose major and minor axes extend along an X and Y axes, respectively.

The dichroic prism 131 is a prism that allows the red laser light beam incident from the lens 12R to selectively pass therethrough, but selectively reflects the green laser light beam incident from the lens 12G. The dichroic prism 132 is a prism that allows the red laser light beam and the green laser light beam incident from the dichroic prism 131 to selectively pass therethrough, but selectively reflects the blue laser light beam incident from the lens 12B. In this way, the red laser light beam, the green laser light beam, and the blue laser light beam are subjected to a color synthesis (or an optical path composition).

The condenser lens 14 is a lens that collects a light beam emitted from the dichroic prism 132, then forming a substantially parallel light beam.

The optical element (diffraction element) 15 is disposed on an optical path of a laser light beam between the light sources and the fly eye lens 17 (specifically, on an optical path between the condenser lens 14 and the fly eye lens 17). This optical element 15 corresponds to a concrete but not limitative example of an “optical element” according to an embodiment of the present disclosure. The diffraction element 15 is an optical element that branches an optical path of an incident light beam Lin into a plurality of optical paths, and outputs the branched light beams as output light beams Lout, for example, as illustrated in FIG. 4. In more detail, the diffraction element 15 splits the incident light ray (incident light beam Lin) into light rays traveling in two or more directions (two or more different directions), and outputs the split light rays as the output light beams Lout. Specifically, the diffraction element 15 changes the optical path of the incident light beam Lin, thereby generating secondary light waves that have phase differences with respect to the incident light beam Lin. Consequently, the light beams Lout do not travel in a single direction but in two or more directions (along which the respective secondary light waves intensify interference therebetween). In this embodiment, the diffraction element 15 diffracts the incident light beam Lin, thereby generating and emitting diffracted light beams of multiple orders (for example, diffracted light beams of 0, +1st to +nth, −1st to −nth orders, etc. in the figure). This diffraction element 15 is also an optical element that decreases speckle noise (interference patterns) which will be described hereinafter, and a laser light beam traveling along the optical axis Z0 illustrated in the figure passes through this optical element 15.

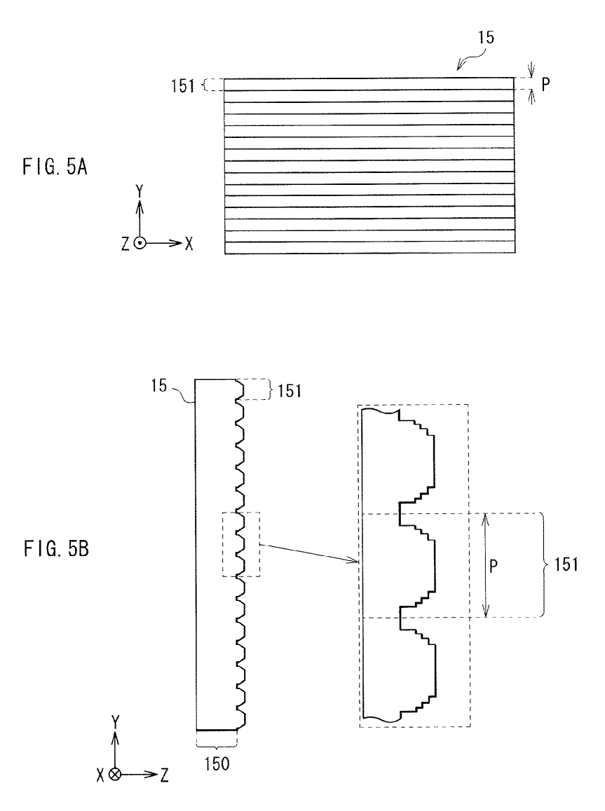

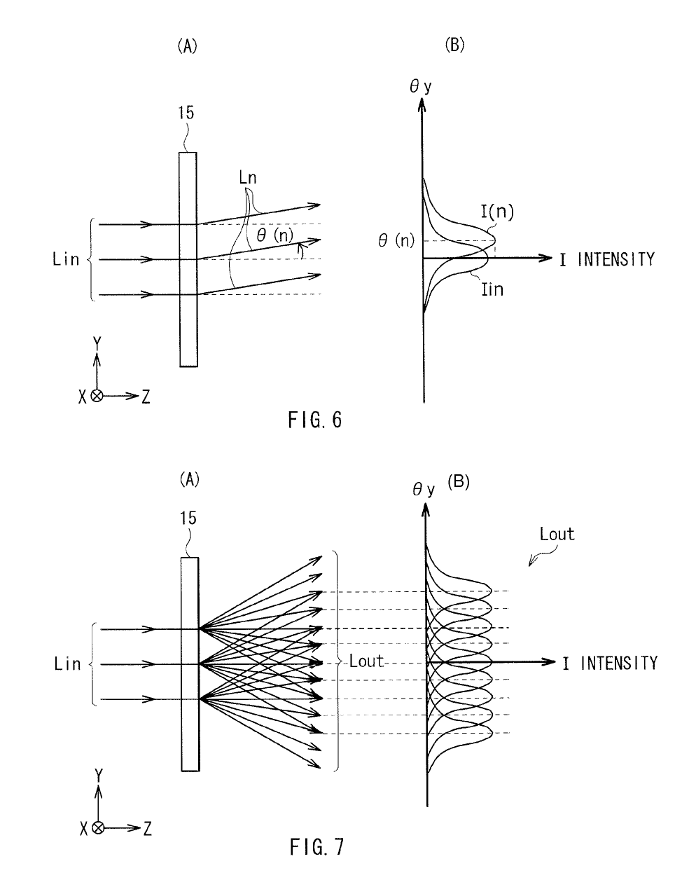

FIGS. 5A and 5B schematically illustrate a detailed configuration of the diffraction element 15: FIG. 5A is a planar configuration (X-Y planar configuration); and FIG. 5B is a cross-sectional configuration (Y-Z cross-sectional configuration). The diffraction element 15 has a configuration in which a substrate 150 (diffraction surface) has thereon a plurality of unit structures (one-dimensional diffraction structures) 151 having a unit pitch P arranged side-by-side (arrayed in a one-dimensional fashion) along a Y axis. Each unit structure 151 has a pair of multi-step surface structures (step surface structures or step structures), each of which extends along an X axis while facing in a direction along which a laser light beam is to be emitted (toward the positive side of a Z axis). Each pair of multi-step surface structures are formed to be symmetric (plane-symmetric) to each other, with respect to a predetermined plane (Z-X plane in this case) containing the normal (parallel to the Z axis) to the diffraction surface (X-Y plane). Specifically, these unit structures 151 are arranged side-by-side in a direction (on the Y axis) orthogonal to a direction (along the X axis) along which the pairs of multi-step surface structures extend within the light emitting surface (X-Y plane). Note that in this embodiment, the pairs of multi-step surface structures in the diffraction element 15 are arranged within the diffraction surface in a one-dimensional fashion, however the structure of the diffraction element 15 is not limited to an embodiment of the present disclosure. Alternatively, pairs of multi-step surface structures may be arranged within the diffraction surface in a two-dimensional fashion.

In the diffraction element 15 configured above, looking at diffracted light beams of a single order (diffracted light beams Ln of a +nth order) among the above diffracted light beams of multiple orders, diffracted light beams having a predetermined diffraction angle θ(n) (diffracted light beams Ln of a +nth order) are generated for light rays contained in the incident light beam Lin, for example, as illustrated in Parts (A) and (B) of FIG. 6. Accordingly, when all the diffracted light beams of multiple orders are considered, the output light beams Lout exhibit an intensity distribution as illustrated in Parts (A) and (B) of FIG. 7.

The driver section 16 drives the above-described diffraction element 15, in such a way that the phases of the branched light beams (diffracted light beams of individual orders) emitted from the diffraction element 15 change independently of one another. Specifically, the driver section 16 (slightly) vibrates the diffraction element 15 in an in-plane direction orthogonal to an optical axis Z0 thereof (or in an in-X-Y plane direction in this case), to thereby change the phases of the branched light beams (diffracted light beams of individual orders) independently of one another. The above driver section 16 is configured by containing, for example, a coil and a permanent magnet such as that made of neodymium (Nd), iron (Fe), boron (B), or the like.

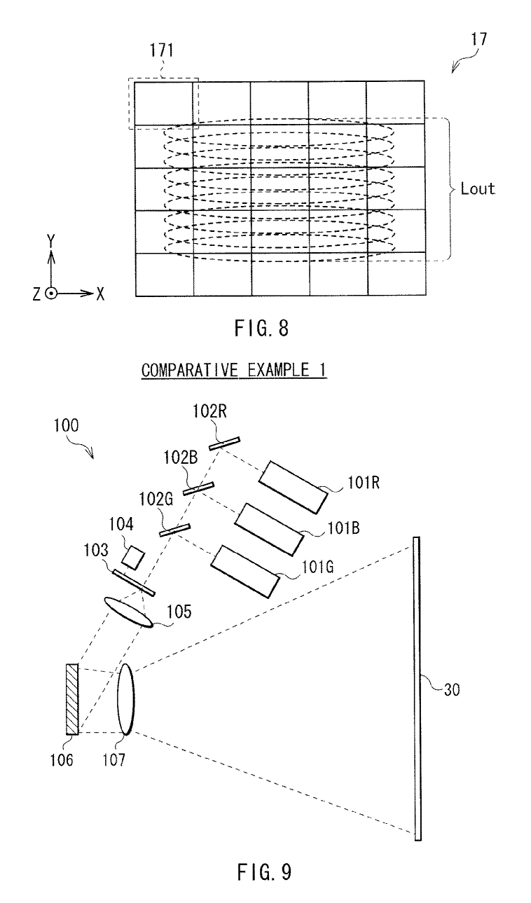

The fly eye lens 17 is an optical member (integrator) having a configuration in which a plurality of lens units 171 are two-dimensionally arranged side-by-side on a substrate (not illustrated), for example, as illustrated in FIG. 8. This fly eye lens 17 spatially separates an incident light ray in accordance with the arrangement of the lens units 171, and emits the separated light rays. As a result, the light ray that has entered this fly eye lens 17 is made uniform (has a uniform intensity distribution within a plane), and is then emitted therefrom as illumination light. In other words, the branched light beams (the diffracted light beams of individual orders) traveling along a plurality of optical paths which have been emitted from the diffraction element 15 enter the fly eye lens 17 (for example, refer to an intensity distribution of output light beams Lout from the diffraction element 15 in FIG. 8). In turn, the illumination light that has been made uniform on the basis of the branched light beams is emitted from the fly eye lens 17. Herein, this fly eye lens 17 corresponds to a concrete but not limitative example of an “optical member” according to an embodiment of the present disclosure.

### (Display Optical System)

The above-described display optical system includes a polarization beam splitter (PBS) 22, a reflective liquid crystal element 21, and a projection lens 23 (or a projection optical system).

The polarization beam splitter 22 is an optical member that allows specific polarized light (for example, P polarized light) to selectively pass therethrough, but selectively reflects another polarized light (for example, S polarized light). In this way, the illumination light (for example, S polarized light) from the illumination device 1 is selectively reflected by the polarization beam splitter 22, and then, enters the reflective liquid crystal element 21. In turn, an optical image (for example, P polarized light) that has been emitted from the reflective liquid crystal element 21 selectively passes through the polarization beam splitter 22, and then, enters the projection lens 23.

The reflective liquid crystal element 21 is a light modulation element that reflects the illumination light from the illumination device 1 while modulating the illumination light, in accordance with an image signal to be supplied from a display control section (not illustrated), thus emitting an optical image. In this embodiment, the reflective liquid crystal element 21 reflects the illumination light, such that respective polarizations (such as S and P polarizations) of incident light and those of reflected light differ from each other. This reflective liquid crystal element 21 may be made of a liquid crystal element of, for example, an LCOS (Liquid Crystal on Silicon) or the like.

The projection lens 23 is a lens which projects (and magnifies) the illumination light (optical image) that has been modulated by the reflective liquid crystal element 21 onto the screen 30.

### Functional Effect of Display Device 3

### 1. Display Operation

In the illumination device 1 of the above-described display device 3, first, the red laser 11R, the green laser 11G, and the blue laser 11B individually emit light beams (laser light beams), and the light beams are converted into parallel light beams by the lenses 12R, 12G, and 12B. Then, the laser light beams (or red, green, and blue laser light beams) which have been collimated in this manner are subjected to the color synthesis (or optical path composition) by the dichroic prisms 131 and 132. The laser light beam that has been subjected to the optical path composition passes through the condenser lens 14 and the diffraction element 15, then entering the fly eye lens 17. This light beam (intensity distribution thereof within the plane) is made uniform by the fly eye lens 17, and is emitted therefrom as illumination light. In this way, the illumination light is emitted from the illumination device 1.

Next, the illumination light is selectively reflected by the polarization beam splitter 22, and then, is incident on the reflective liquid crystal element 21. The incident light is reflected by the reflective liquid crystal element 21 while being modulated in accordance with an image signal. Then, the reflected, modulated light is emitted therefrom as an optical image. In this case, light incident on the reflective liquid crystal element 21 and light emitted therefrom differ in polarization from each other. Accordingly, the optical image emitted from the reflective liquid crystal element 21 selectively passes through the polarization beam splitter 22 and, then enters the projection lens 23. Finally, this light (optical image) is (magnified and) projected onto the screen 30 by the projection lens 23.

In this embodiment, the red laser 11R, the green laser 11G, and the blue laser 11B sequentially emit (pulse) light beams in a time division manner. Thus, the laser light beams (red, green, and blue laser light beams) are emitted therefrom. Following this, the laser light beams of corresponding colors are modulated sequentially in a time division manner, in accordance with an image signal containing color components (red, green, and blue components) by the reflective liquid crystal element 21. In this way, the display device 3 displays a color image according to the image signal.

### 2. Functional Effect

Next, a description will be given below in detail, of a functional effect which the illumination device 1 produces, in comparison with a comparative example.

### 2-1. Comparative Example 1

FIG. 9 illustrates an overall configuration of a display device (display device 100) according to a comparative example 1. The display device 100 of the comparative example 1 is a projection display device that projects an optical image onto the screen 30, similar to the display device 3 of this embodiment. This display device 100 includes a red laser 101R, a green laser 101G, a blue laser 101B, dichroic mirrors 102R, 102G, and 102B, a diffusing element 103, a motor (driver section) 104, a lens 105, a light modulation element 106, and a projection lens 107.

In the display device 100, the red laser 101R, the green laser 101G, and the blue laser 101B emit laser light beams of corresponding colors, and then, the dichroic mirrors 102R, 102G, and 102B subject the laser light beams to a color synthesis (optical path composition). The synthesized light beam enters the diffusing element 103. The diffusing element 103 scatters the incident light beam, and the lens 105 irradiates the light modulation element 106 with the light beam as illumination light. This light modulation element 106 reflects the illumination light while modulating the illumination light, in accordance with an image signal, then emitting the reflected, modulated light as an optical image. The projection lens 107 (magnifies and) projects the optical image onto the screen 30. In this way, the display device 100 displays a color image according to the image signal.

Generally, when coherent light, such as laser light, is irradiated on a diffusing surface, spotty patterns are observed thereon, as opposed to using other types of light. Such patterns are called “speckle patterns”. The light irradiated on the diffusing surface is scattered thereon, and scattered lights having random phases in accordance with the unevenness of the surface interfere with one another, so that speckle patterns are generated.

When a projector provided with a laser light source, such as the above display device 100 of the comparative example, projects an optical image onto a screen, speckle patterns (or interference patterns) may be overlaid over an image displayed on the screen. Because these patterns are recognized as intense random noises by human eyes, the displayed image quality is lowered.

In order to reduce the generation of such speckle patterns (or speckle noises) in a projector provided with a laser light source, a technique of slightly vibrating a screen may be contemplated. Generally, it is difficult for human eyes and brains to recognize flickers appearing on an image in a period of approximately 20 ms to 50 ms. Thus, human eyes integrate and average the variation in an image over this period. Therefore, by overlaying a lot of independent speckle patterns on a screen, the speckle noises are averaged so as to be less prominent for human eyes. However, this technique may involve the enlargement of the configuration in the device, in order to slightly vibrate the large screen itself. Also, this technique possibly causes a concern about high power consumption, a loud noise, and the like.

In consideration of the above, in the display device 100 of the comparative example 1, the motor 104 mechanically rotates the diffusing element 103, thereby displacing speckle patterns on the screen 30 at a high speed and reducing the generation of the speckle noises. However, because the diffusing element 103 is used to diffuse incident light, this technique may disadvantageously impair the utilization efficiency of the light.

### 2-2. Effect of Embodiment

In contrast, the illumination device 1 of this embodiment has solved the above-described disadvantage in the following manner, by using the optical element (diffraction element) 15.

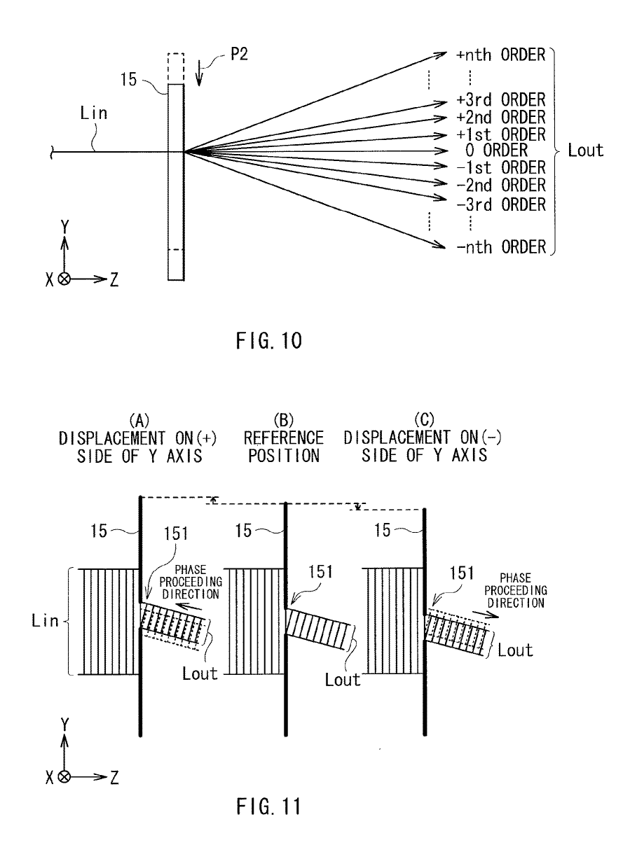

First, the diffraction element 15 emits output light beams Lout by branching the optical path of an incident light beam Lin into a plurality of optical paths, as illustrated in FIGS. 4 and 10. In more detail, by diffracting the incident light beam Lin with the diffraction element 15, diffracted light beams of multiple orders (0, +1st to +nth, −1st to −nth orders, etc.) are generated as output light beams Lout.

Next, the driver section 16 drives the diffraction element 15, in such a way that the phases of the branched light beams (the diffracted light beams of individual orders) emitted from the diffraction element 15 change independently of one another. In more detail, the driver section 16 (slightly) vibrates the diffraction element 15 in an in-plane direction orthogonal to an optical axis Z0 thereof (or in a direction of an in-X-Y plane), to thereby change the phases of the branched light beams (diffracted light beams of individual orders) independently of one another. For example, as indicated by an arrow P2 in FIG. 10, the driver section 16 vibrates the diffraction element 15 within a plane (X-Y plane) orthogonal to the optical axis Z0 in a direction along which an array direction component (Y-axis component) of the unit structures 151 is contained. In this example, the driver section 16 vibrates the diffraction element 15 in a direction along which the unit structures 151 are arrayed (or along the Y axis). As a result, with the above principle (overlaying (temporal averaging) of speckle patterns) as well as spatial overlaying thereof, the generation of the speckle noise (interference patterns) due to laser light is reduced.

Here, in an example where the diffraction element 15 is provided with a simple diffraction structure (or a through hole) as illustrated in Parts (A) to (C) of FIG. 11, the phases of branched light beams that have been emitted from the diffraction element 15 change independently of one another in the following manner. Specifically, the position of the diffraction element 15 which is illustrated in Part (B) of FIG. 11 is assumed to be a reference position. Then, when the diffraction element 15 is located at a position illustrated in Part (A) of FIG. 11 (or when the diffraction element 15 is displaced toward the positive side of a Y axis), the phases of the output light beams Lout (diffracted light beams of individual orders) relatively change (proceed) toward the negative side of a Z axis (or the side of the diffraction element 15), in comparison with the phases at the reference position. Meanwhile, when the diffraction element 15 is located at a position illustrated in Part (C) of FIG. 11 (or when the diffraction element 15 is displaced toward the negative side of the Y axis), the phases of the output light beams Lout (diffracted light beams of individual orders) relatively change (proceed) toward the positive side of the Z axis (or the opposite side to the diffraction element 15), in comparison with the phases at the reference position. In this way, the diffraction element 15 vibrates within a plane orthogonal to the optical axis Z0 (X-Y plane) in a direction along which the array direction component (Y-axis component) is contained. This causes the output light beam Lout (diffracted light beams of individual orders) to be changed with the emission angle thereof being maintained. Consequently, the effect in which speckle patterns are overlaid temporally and spatially in the above manner decreases the speckle patterns.

Also, in this embodiment, the branched light beams (diffracted light beams of individual orders) emitted from the diffraction element 15 enter the fly eye lens 17, and then, the illumination light is emitted therefrom, on the basis of these branched light beams. This configuration decreases or prevents an optical loss produced when the light beams enter the fly eye lens 17 from the diffraction element 15 (or decreases or prevents the incident loss of the branched light beams), even when the above optical element is driven (or is slightly vibrated in an in-plane direction orthogonal to the optical axis Z0). Consequently, the optical loss (incident loss) of the laser light is minimized or prevented, which is produced when the speckle noise is overlaid so as to be decreased, as opposed to the technique employed by the above comparative example 1 or other techniques such as that of slightly vibrating the diffraction element 15 along the optical axis Z0.

As described above, in this embodiment, there is provided, the optical element 15 that emits light beams by branching an optical path of an incident light beam Lin including a laser light beam into a plurality of optical paths, and the fly eye lens 17 that receives the branched light beams and emits illumination light. In addition, the diffraction element 15 is driven so as to change the phases of the branched light beams independently of one another. This configuration decreases or prevents the optical loss produced when the light beam enters the fly eye lens 17 from the diffraction element 15, while reducing the generation of interference patterns due to laser light. Consequently, it is possible to achieve the compactness as well as improve the utilization efficiency of light while reducing the generation of interference patterns (or improve the displayed image quality).

### EXAMPLES

Next, a description will be given of specific examples (Examples 1 and 2) according to the above-described embodiment.

### Example 1

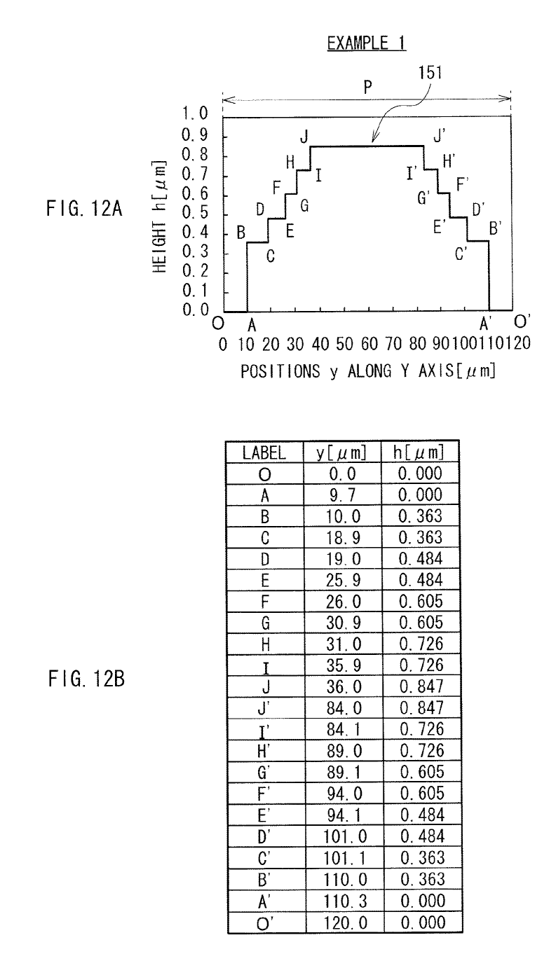

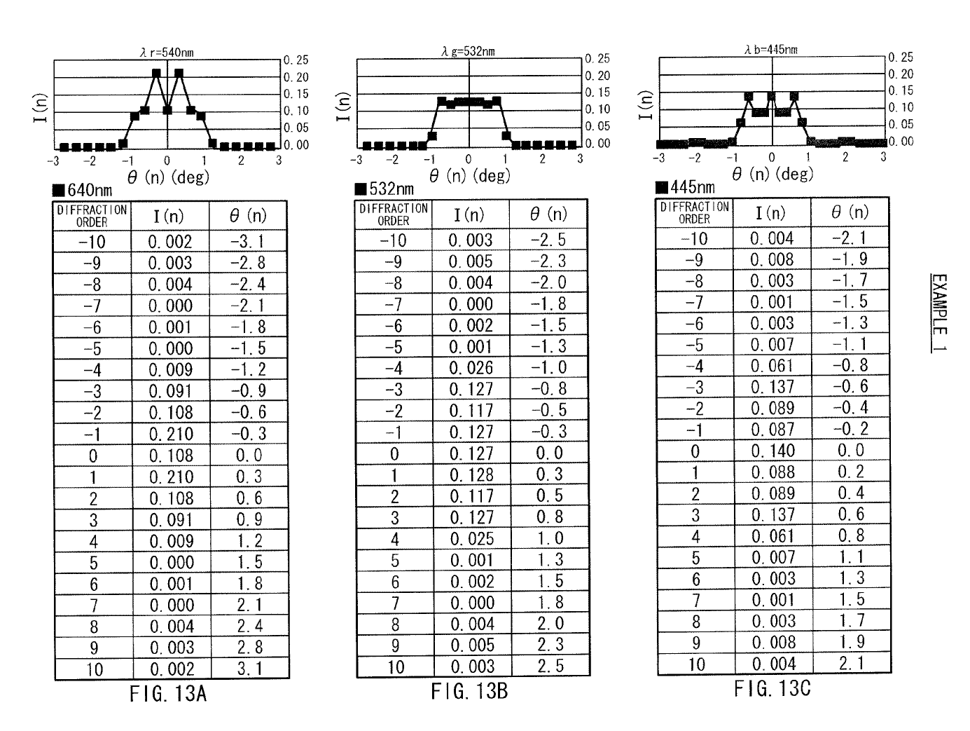

FIGS. 12A and 12B depict a configuration of a diffraction element 15 according to Example 1. Specifically, FIGS. 12A and 12B depict positions (positions y along the Y axis) on a surface indicated by individual labels (A to J, A′ to J′, O, and O′) in each unit structure 151 (a one-dimensional diffraction structure which was constituted by pairs of step surface structures having the unit pitch P) of the diffraction element 15, and heights “h” of these positions. In addition, FIGS. 13A to 13C depict diffraction characteristics (calculation values) which the diffraction element 15 of FIGS. 12A and 12B had. In more detail, FIGS. 13A to 13C depict a relationship among diffraction orders, intensities I(n), and angles θ(n) of diffracted light beams which were emitted from the diffraction element 15, under a condition (A) that red laser light Lr had a wavelength of 640 nm, a condition (B) that green laser light Lg had a wavelength of 532 nm, and a condition (C) that blue laser light Lb had a wavelength of 445 nm.

As is evident from FIGS. 12A, 12B, and 13A to 13C, in each of the red laser light Lr, the green laser light Lg, and the blue laser light Lb, the diffracted light beams of 0, ±1st, ±2nd, and ±3rd orders (diffracted light beams of seven orders) exhibited a diffraction efficiency (of substantially equal to or more than 10%) which was much higher than those of the other orders. In view of this result, it is desirable for both the diffraction element 15 and the unit structures 151 to be formed such that diffracted light beams of substantially the same intensity (light quantity) (or of substantially the same luminance for the luminosity factor of human eyes) are generated for as many orders as possible.

### Example 2

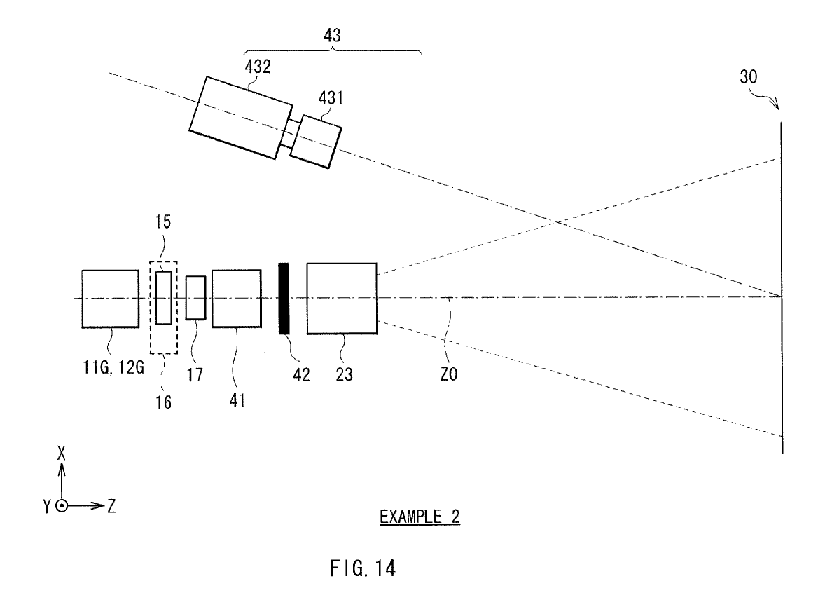

FIG. 14 is a schematic view illustrating a configuration of a measurement system for interference patterns according to Example 2. This measurement system for Example 2 included the green laser 11G, the lens 12G, the diffraction element 15, the driver section 16, the fly eye lens 17, a telecentric optical system 41, a rectangular aperture 42, the projection lens 23, the screen 30, and an image pickup device 43 having a charge-coupled device (CCD) 432 and an image pickup lens 431. Note that among these components of the measurement system, a light source unit including the green laser 11G and the lens 12G, the driver section 16, the aperture 42, the projection lens 23, an image projected onto the screen 30, and the image pickup device 43 had the following detailed structures.

### (Detailed Structure)

Light source unit: a green laser light beam Lg (parallel light beam) of a wavelength=532 nm and a diameter φ=6 mm

Driver section 16: a vibration amplitude=0.3 mm (along the Y axis), and a vibration frequency=90 Hz

Aperture 42: an aspect ratio=16:9

Projection lens 23: F number=2.0, and a focal length=5 mm

Projected image: 25 inch

Image pickup device 43: a resolution=1392×1040 pixels, a size=⅔ inch, F number=16, a focal length=50 mm, and an object distance=933 mm

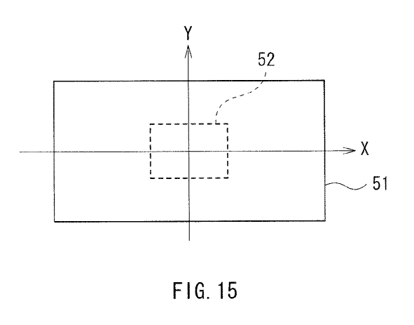

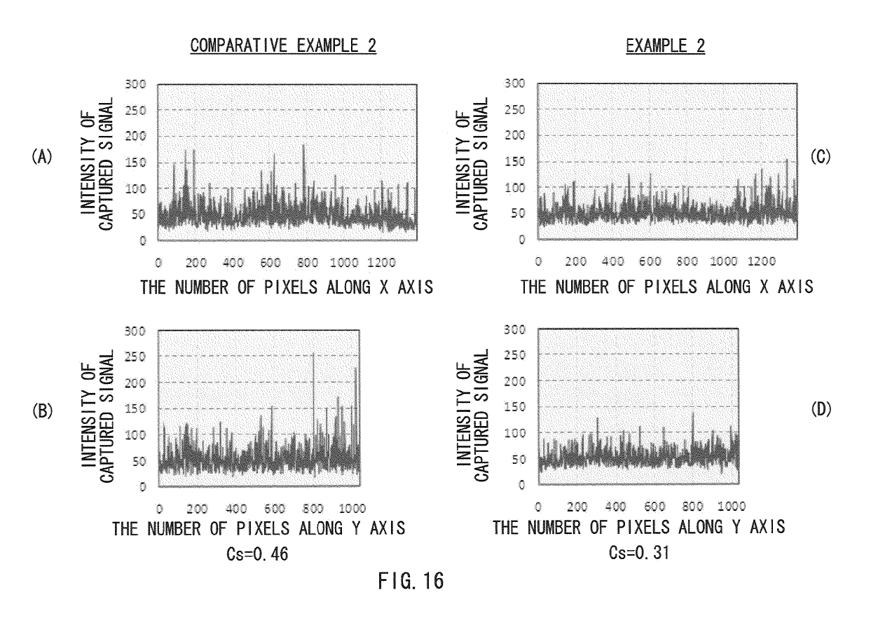

A positional relationship between a projected region 51 where a projected image appeared on the screen 30 and a measurement region (image pickup region) 52 captured by the image pickup device 43 was, for example, as illustrated in FIG. 15. Specifically, a measurement condition (luminance profile) of a speckle contrast Cs (an index indicating the degree of the generation of speckle patterns), which is specified by the following expression (1), was as follows.

Cs=(σ/I) (1)

(where σ denotes the standard deviation of a luminance distribution (or an intensity distribution), and I denotes an average value of the luminance distribution.)

### (Measurement Condition)

Measurement numeric value: luminance gradation

Measurement region 52: a central area defined at the center of the projected region 51 along the X and Y axes

Measurement directions: two directions within the measurement region 52 along the X and Y axes

Parts (A) and (B) of FIG. 16 depict a measurement result of interference patterns generated in a comparative example 2 (an example in which both the diffraction element 15 and the driver section 16 were removed from the measurement system illustrated in FIG. 14). Meanwhile, parts (C) and (D) of FIG. 16 depict a measurement result of interference patterns generated in Example 2. In more detail, Parts (A) and (C) of FIG. 16 correspond to the measurement result under the condition that the measurement direction was along the X axis, and depict a relationship between the number of pixels (the number of pixels in a captured image) on the X axis and the intensity (luminance) of a captured signal on the X axis. Meanwhile, Parts (B) and (D) of FIG. 16 correspond to the measurement result under the condition that the measurement direction was along the Y axis, and depict a relationship between the number of pixels (the number of pixels in a captured image) on the Y axis and the intensity (luminance) of a captured signal on the Y axis. As is evident from Parts (A) to (D) of FIG. 16, Example 2 (speckle contrast Cs=0.31) exhibited a lower degree of the generation of speckle patterns than the comparative example 2 (speckle contrast Cs=0.46). In other words, it is understood that there is an improvement in the displayed image quality of Example 2.

### Modification Example

Next, a description will be given of modification examples (modification examples 1 to 3) of the above-described embodiment. It should be noted that the same reference numerals are assigned to the same components as those in the embodiment, and a description thereof will be omitted as appropriate.

### Modification Example 1

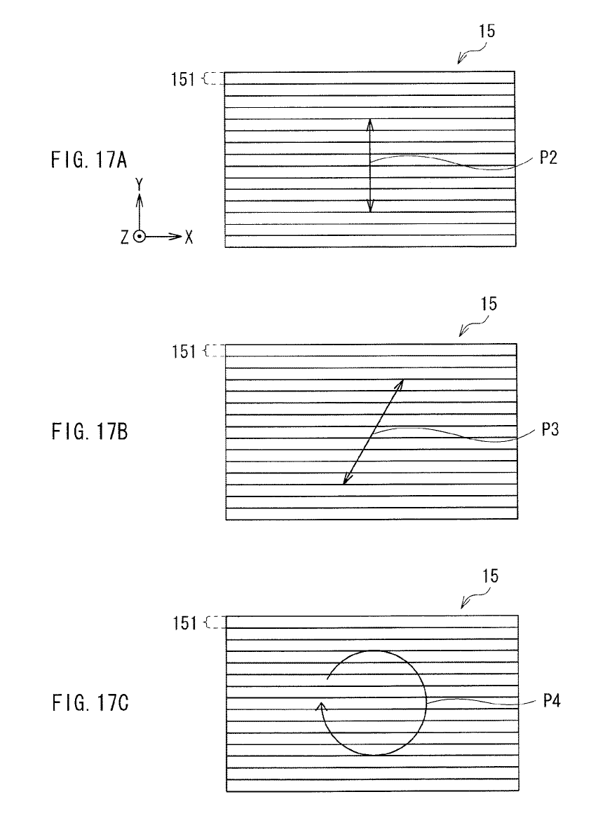

In the above-described embodiment, the driver section 16 vibrates the diffraction element 15 in the direction along which the unit structures 151 are arrayed (or along the Y axis), for example, as indicated by an arrow P2 in FIG. 17A. However, an embodiment of the present disclosure is not limited thereto. Specifically, the diffraction element 15 may be vibrated in a way such as that described in a modification example 1 that will be described below, as long as being vibrated within a plane (X-Y plane) orthogonal to the optical axis Z0 in a direction along which the array direction component (Y axis component) of the unit structures 151 is contained.

For example, the diffraction element 15 may be vibrated within a plane (X-Y plane) orthogonal to the optical axis Z0, for example, in an oblique direction along which the array direction component (Y axis component) of the unit structures 151 is contained (or in a direction that is not parallel to any of the X and Y axes), as indicated by an arrow P3 in FIG. 17B. Alternatively, the diffraction element 15 may be vibrated within a plane (X-Y plane) orthogonal to the optical axis Z0 with a circular movement whose orbit contains the array direction component (Y axis component) of the unit structures 151, for example, as indicated by an arrow P4 in FIG. 17C.

It is also possible for even this modification example which employs the above technique to fulfill the same function as that of the embodiment or the like, and to produce the same effect. In other words, it is possible to achieve the compactness as well as improve the utilization efficiency of light while reducing the generation of interference patterns (or improving the displayed image quality).

### Modification Example 2

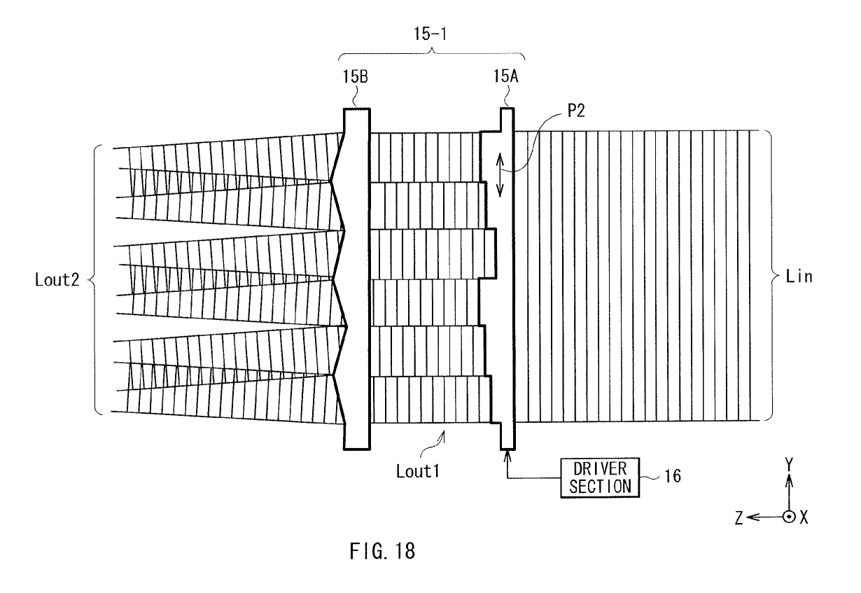

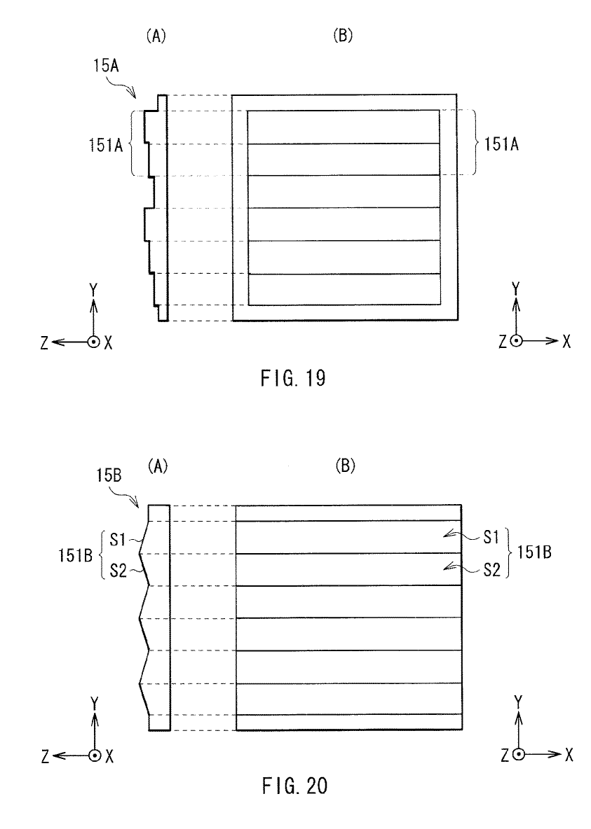

FIG. 18 is a schematic view illustrating a configuration (X-Z cross-sectional configuration) and a function of an optical element (optical element 15-1) according to a modification example 2. An illumination device of this modification example includes a plurality of optical elements, as a concrete but not limitative example of the “optical element” according to an embodiment of the present disclosure, and the other configurations thereof are the same as those of the illumination device 1. Note that FIG. 18 schematically illustrates the equiphase wave surfaces of an incident light beam Lin and output light beams Lout1 and Lout2, and the subsequent similar figures illustrate views in the similar manner.

The optical element 15-1 is an optical system in which a plurality of optical elements are arranged along an optical axis Z0 while opposing each other. In this example, a phase change element 15A and a prism array (prism element) 15B, which will be described below, are arranged along the optical axis Z0 in this order from the positive side of the Z axis.

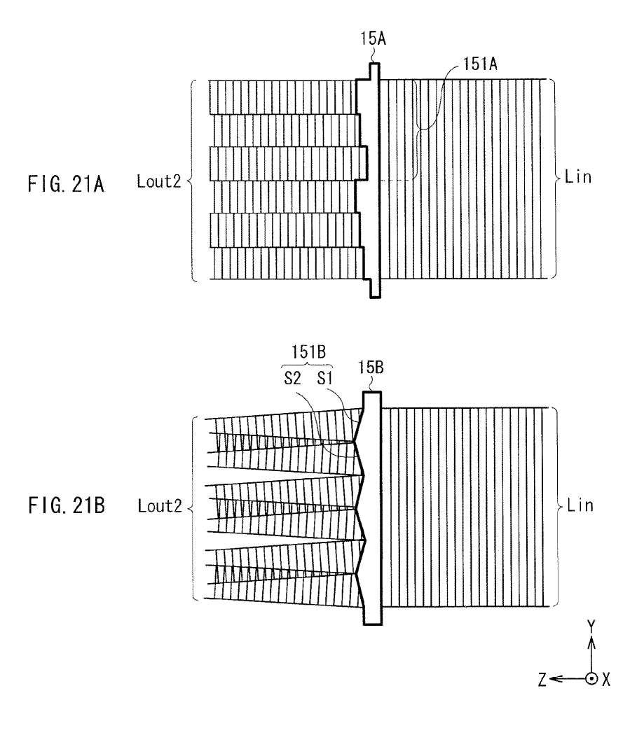

The phase change element 15A has a configuration in which a plurality of unit structures 151A are arranged (or arrayed) side-by-side along the Y axis, for example, as illustrated in Parts (A) and (B) of FIG. 19. Each unit structure 151A has multi-step surface structures (step surface structures or step structures), each of which extends along an X axis while facing in a direction along which a laser light beam is to be emitted (toward the positive side of the Z axis). In other words, these unit structures 151A are arranged side-by-side in a direction (along the Y axis) orthogonal to that (along the X axis) along which the multi-step structures extend within the light emitting surface (X-Y plane). The phase change element 15A configured above emits the output light beams Lout1 by changing the phases of respective parts of the incident light beam Lin which correspond to predetermined unit regions (each of which has a single unit structure 151A formed therein) independently of one another, for example, as illustrated in FIG. 21A.

The prism array 15B has a configuration in which a plurality of unit structures (prism) 151B are arranged (or arrayed) side-by-side along the Y axis, for example, as illustrated in Parts (A) and (B) of FIG. 20. Each unit structure 151B has inclined surface structures (each composed of a pair of inclined surfaces S1 and S2), each of which extends along an X axis while facing in a direction along which a laser light beam is to be emitted (toward the positive side of the Z axis). In other words, these unit structures 151B are arranged side-by-side in a direction (along the Y axis) orthogonal to that (along the X axis) along which the inclined surface structures extend within the light emitting surface (X-Y plane). The prism array 15B configured above emits the output light beams Lout2 by branching the optical path of the incident light beam Lin into a plurality of optical paths (two optical paths in this case), for example, as illustrated in FIG. 21B.

In this modification example, the driver section 16 selectively drives the phase change element 15A of the optical element 15-1, for example, as indicated by an arrow P2 in FIG. 18. Concretely, by employing the technique described in the above embodiment or modification example 1, the phase change element 15A is vibrated in an in-plane direction orthogonal to the optical axis Z0 thereof (or an in-X-Y plane direction).

In the overall configuration of the optical element 15-1, first, the phases of respective parts of the incident light beam Lin which correspond to predetermined unit regions (each of which has a single unit structure 151A formed therein) are changed by the phase change element 15A, independently of one another, and the output light beams Lout1 are emitted from the phase change element 15A, as illustrated in FIG. 18. Subsequently, the optical path of the output light beams Lout1 from the phase change element 15A is branched into two optical paths by the prism array 15B, and the output light beams Lout2 are emitted from the prism array 15B. Thus, the optical element 15-1 produces, as a whole, the same functional effect as that which the diffraction element 15 having been described in the above embodiment produces.

Accordingly, it is also possible for even this modification example to fulfill the same function as that of the above embodiment or the like, and to produce the same effect. In other words, it is possible to achieve the compactness as well as improve the utilization efficiency of light while reducing the generation of interference patterns (or improving the displayed image quality).

### Modification Example 3

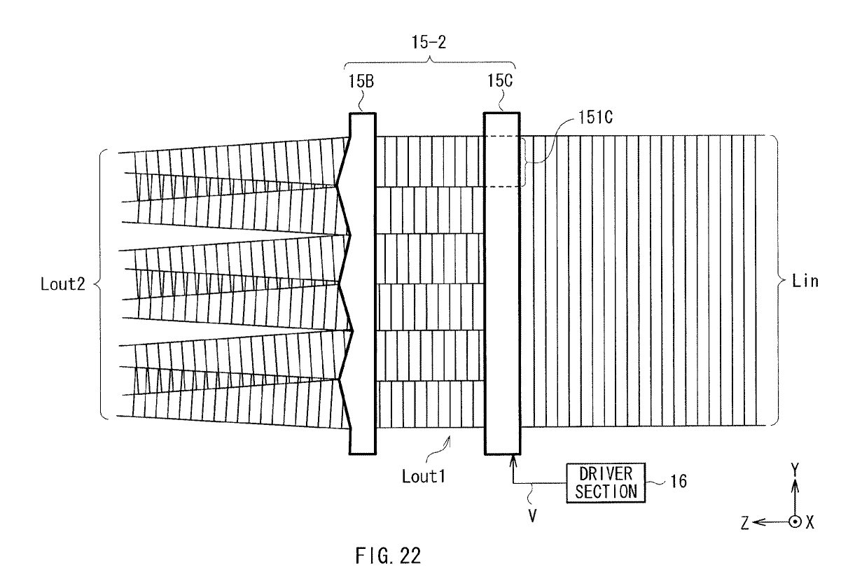

FIG. 22 is a schematic view illustrating a configuration (X-Z cross-sectional configuration) and a function of an optical element (optical element 15-2) according to a modification example 3. Similar to the above modification example 2, an illumination device of this modification example includes a plurality of optical elements, as a concrete but not limitative example of the “optical element” according to an embodiment of the present disclosure, and the other configurations thereof are the same as those of the illumination device 1.

In this modification example, however, the optical element 15-2 differs from the optical element 15-1 in the modification example 2, in including a liquid crystal element 15C which will be described below, instead of the phase change element 15A.

The liquid crystal element 15C is a phase change element in which a predetermined unit structure 151C is formed for each predetermined unit region, and is configured to emit output light beams Lout1 by changing the phases of respective parts of incident light beam Lin which correspond to the unit regions (each of which a single unit structure 151C is formed therein), independently of one another.

In this modification example, the driver section 16 selectively drives the liquid crystal element 15C of the optical element 15-2, for example, as illustrated in FIG. 22. Specifically, the driver section 16 applies predetermined drive voltages V to the liquid crystal element 15C for the individual unit structures 151C. In this way, the phases of respective parts of incident light beam Lin which correspond to the unit regions (each of which a single unit structure 151C is formed therein) are changed independently of one another, as described above.

In the overall configuration of the optical element 15-2, first, the phases of respective parts of the incident light beam Lin which correspond to the predetermined unit regions (each of which has a single unit structure 151C is formed therein) are changed independently of one another by the liquid crystal element 15C, and the output light beams Lout1 are emitted from the liquid crystal element 15C, as illustrated in FIG. 22. Subsequently, the optical path of the output light beams Lout1 from the liquid crystal element 15C is branched into two optical paths by the prism array 15B, and the output light beams Lout2 are emitted from the prism array 15B. Thus, the optical element 15-2 produces, as a whole, the same functional effect as that which the diffraction element 15 having been described in the above embodiment produces.

Accordingly, it is also possible for even this modification example to fulfill the same function as that of the above embodiment or the like, and to produce the same effect. In other words, it is possible to achieve the compactness as well as improve the utilization efficiency of light while reducing the generation of interference patterns (or improving the displayed image quality).

### Other Modification Examples

Up to this point, the techniques of the present disclosure have been described by exemplifying the embodiment, Examples, and the modification examples, however this technique is not limited to the embodiment and the like, and various variations are possible.

For example, the above embodiment and the like have been described by giving the diffraction element, the combination of the phase change element and the prism array, and the combination of the liquid crystal element and the prism array, as examples of the “optical element” according to an embodiment of the present disclosure, however any element aside from these examples may be used. In addition, any optical member (for example, a rod integrator or the like) other than the fly eye lens having been described in the above embodiment and the like may also be used as the “optical member” according to an embodiment of the present disclosure.

In the above embodiment and the like, the case has been described, where each of multiple types (red, green, and blue types) of light sources is a laser light source, however an embodiment of the present disclosure is not limited to this case. Alternatively, at least one of the multiple types of light sources may be a laser light source. Specifically, a combination of a laser light source and light sources aside from laser light sources (for example, LED light sources or the like) may be provided in the light source section.

In the above embodiment and the like, the case has been described, where an example of the light modulation element is the reflective light modulation element, however, the present disclosure is not limited thereto. Alternatively, for example, a transmissive liquid crystal element may be used instead. Furthermore, any light modulation element aside from a liquid crystal element may be used.

In the above embodiment and the like, the case has been described, where the three types of light sources that emit light beams of different wavelengths are used, but, for example, not only three types of light sources but also a single type, two types, or four or more types of light sources may be used.

The above embodiment and the like have been described by giving specific (optical) components of the illumination device and the display device. However, providing all of the components is not necessary, and any other components may be added. Concretely, for example, dichroic mirrors may be provided, instead of the dichroic prisms 131 and 132.

In the embodiment and the like, the case has been described, where the display device is equipped with the projection optical system (projection lens) that projects light modulated by the light modulation element onto the screen, and is configured as a projection display device. However, the present technology is also applicable to, for example, direct-view display devices.

Accordingly, it is possible to achieve at least the following configurations from the above-described example embodiments and the modifications of the disclosure.

(1) An illumination device, including:

a light source section including a laser light source;

an optical element disposed on an optical path of a laser light beam emitted from the laser light source, the optical element branching an optical path of an incident light beam incident thereon into a plurality of optical paths, and allowing branched light beams to be output therefrom;

an optical member receiving the branched light beams that travel along the plurality of optical paths, and allowing illumination light to be output therefrom based on the branched light beams; and

a driver section driving the optical element to allow phases of the branched light beams to be changed independently of one another.

(2) The illumination device according to (1), wherein the optical element includes a diffraction element having a plurality of predetermined unit structures that are arrayed therein.
(3) The illumination device according to (2), wherein the driver section vibrates the diffraction element in an in-plane direction that is substantially orthogonal to an optical axis thereof, to allow the phases, of diffracted light beams of individual orders structuring the branched light beams, to be changed independently of one another.
(4) The illumination device according to (3), wherein the driver section vibrates the diffraction element within the plane substantially orthogonal to the optical axis, in a direction along which an array direction component of the unit structures is contained.
(5) The illumination device according to (4), wherein the driver section vibrates the diffraction element in a direction along which the unit structures are arrayed.
(6) The illumination device according to any one of (2) to (5), wherein

each of the unit structures includes a pair of multi-step surface structures that are symmetric to each other with respect to a predetermined plane containing a normal to a diffraction surface, and

the pair of multi-step surface structures are arrayed on the diffraction surface in one of an one-dimensional fashion and a two-dimensional fashion.

(7) The illumination device according to (1), wherein

the optical element includes a phase change element and a prism array that are arranged along respective optical axes thereof while opposing each other,

the phase change element changes, for respective predetermined unit regions, phases of respective parts of the incident light beam independently of one another, and allows phase-changed light beams to be output therefrom,

the prism array branches an optical path of the phase-changed light beams output from the phase change element into the plurality of optical paths, and allows the branched light beams to be output therefrom, and

the driver section drives the phase change element.

(8) The illumination device according to (7), wherein the driver section vibrates the phase change element in an in-plane direction that is substantially orthogonal to the optical axis thereof
(9) The illumination device according to (7), wherein

the phase change element includes a liquid crystal element having predetermined unit structures that are formed corresponding to the respective unit regions, and

the driver section applies a predetermined drive voltage to the liquid crystal element for each of the unit structures.

(10) The illumination device according to any one of (1) to (9), wherein the optical member includes a fly eye lens.
(11) The illumination device according to any one of (1) to (10), wherein the light source section includes three types of light sources that emit red, green, and blue light beams.
(12) The illumination device according to (11), wherein one or more of the three types of light source are laser light sources.
(13) A display device with an illumination device and a light modulation element, the light modulation element modulating illumination light derived from the illumination device based on an image signal, the illumination device including:

a light source section including a laser light source;

an optical element disposed on an optical path of a laser light beam emitted from the laser light source, the optical element branching an optical path of an incident light beam incident thereon into a plurality of optical paths, and allowing branched light beams to be output therefrom;

an optical member receiving the branched light beams that travel along the plurality of optical paths, and allowing the illumination light to be output therefrom based on the branched light beams; and

a driver section driving the optical element to allow phases of the branched light beams to be changed independently of one another.

(14) The display device according to (13), further including a projection optical system projecting the illumination light modulated by the modulation element onto a projection surface.
(15) The display device according to (13) or (14), wherein the light modulation element includes a liquid crystal element.

The present disclosure contains subject matter related to that disclosed in Japanese Priority Patent Application JP 2011-180779 filed in the Japan Patent Office on Aug. 22, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An illumination device, comprising:
a light source section including a laser light source;
an optical element disposed on an optical path of a laser light beam emitted from the laser light source, the optical element branching an optical path of an incident light beam incident thereon into a plurality of optical paths, and allowing branched light beams to be output therefrom;
an optical member receiving the branched light beams that travel along the plurality of optical paths, and allowing illumination light to be output therefrom based on the branched light beams; and
a driver section driving the optical element to allow phases of the branched light beams to be changed independently of one another.

2. The illumination device according to claim 1, wherein the optical element includes a diffraction element having a plurality of predetermined unit structures that are arrayed therein.

3. The illumination device according to claim 2, wherein the driver section vibrates the diffraction element in an in-plane direction that is substantially orthogonal to an optical axis thereof, to allow the phases, of diffracted light beams of individual orders structuring the branched light beams, to be changed independently of one another.

4. The illumination device according to claim 3, wherein the driver section vibrates the diffraction element within the plane substantially orthogonal to the optical axis, in a direction along which an array direction component of the unit structures is contained.

5. The illumination device according to claim 4, wherein the driver section vibrates the diffraction element in a direction along which the unit structures are arrayed.

6. The illumination device according to claim 2, wherein
each of the unit structures includes a pair of multi-step surface structures that are symmetric to each other with respect to a predetermined plane containing a normal to a diffraction surface, and
the pair of multi-step surface structures are arrayed on the diffraction surface in one of an one-dimensional fashion and a two-dimensional fashion.

7. The illumination device according to claim 1, wherein
the optical element includes a phase change element and a prism array that are arranged along respective optical axes thereof while opposing each other,
the phase change element changes, for respective predetermined unit regions, phases of respective parts of the incident light beam independently of one another, and allows phase-changed light beams to be output therefrom,
the prism array branches an optical path of the phase-changed light beams output from the phase change element into the plurality of optical paths, and allows the branched light beams to be output therefrom, and
the driver section drives the phase change element.

8. The illumination device according to claim 7, wherein the driver section vibrates the phase change element in an in-plane direction that is substantially orthogonal to the optical axis thereof.

9. The illumination device according to claim 7, wherein
the phase change element includes a liquid crystal element having predetermined unit structures that are formed corresponding to the respective unit regions, and
the driver section applies a predetermined drive voltage to the liquid crystal element for each of the unit structures.

10. The illumination device according to claim 1, wherein the optical member includes a fly eye lens.

11. The illumination device according to claim 1, wherein the light source section includes three types of light sources that emit red, green, and blue light beams.

12. The illumination device according to claim 11, wherein one or more of the three types of light source are laser light sources.

13. A display device with an illumination device and a light modulation element, the light modulation element modulating illumination light derived from the illumination device based on an image signal, the illumination device comprising:
a light source section including a laser light source;
an optical element disposed on an optical path of a laser light beam emitted from the laser light source, the optical element branching an optical path of an incident light beam incident thereon into a plurality of optical paths, and allowing branched light beams to be output therefrom;
an optical member receiving the branched light beams that travel along the plurality of optical paths, and allowing the illumination light to be output therefrom based on the branched light beams; and
a driver section driving the optical element to allow phases of the branched light beams to be changed independently of one another.

14. The display device according to claim 13, further comprising a projection optical system projecting the illumination light modulated by the modulation element onto a projection surface.

15. The display device according to claim 13, wherein the light modulation element includes a liquid crystal element.
